(19) United States
(12) Patent Application Publication
(10) Pub. No.: US 2026/0118278 A1
(43) Pub. Date: Apr. 30, 2026

(54) OPTICAL COHERENCE TOMOGRAPHY APPARATUS AND METHOD FOR INSPECTING DISPLAY DEVICE USING THE SAME

(71) Applicants: Samsung Display Co., LTD., Yongin-si (KR); Kyungpook National University Industry-Academic Cooperation Foundation, Daegu (KR)

(72) Inventors: TAE-JIN HWANG, Yongin-si (KR); Mansik JEON, Daegu (KR); Sangyeob HAN, Daegu (KR); HEUNG-WOO JUNG, Yongin-si (KR); KI-HOON JUNG, Yongin-si (KR)

(21) Appl. No.: 19/209,268

(22) Filed: May 15, 2025

(30) Foreign Application Priority Data
Oct. 28, 2024 (KR) 10-2024-0148670

(51) Int. Cl. G01N 21/88

(52) U.S. Cl. CPC G01N 21/8806; G01N 21/8851; G01N 2201/0633; G01N 2201/104

(57) ABSTRACT

An optical coherence tomography apparatus includes a light source for emitting source light, a splitter for dividing the source light into (1-1)-th light and (1-2)-th light, a reference group for receives the (1-1)-th light and including a mirror reflecting the received (1-1)-th light back to the splitter, a sample group for inspecting a display panel using the (1-2)-th light and then reflecting the (1-2)-th light reflected from the display panel back to the splitter, a detector for converting an interference signal into an electrical signal, and a processing unit for receiving the electrical signal from the detector and generating a tomographic image. The splitter generates the interference signal by combining the (1-1)-th light reflected from the reference group and the (1-2)-th light reflected from the sample group. Speed at which the sample group inspects the display panel is variable.

This application claims priority to Korean Patent Application No. 10-2024-0148670, filed on Oct. 28, 2024, and all the benefits accruing therefrom under 35 U.S.C. § 119, the content of which in its entirety is herein incorporated by reference.

### BACKGROUND

The present disclosure herein relates to an optical coherence tomography apparatus and a method for inspecting a display device using the same.

Optical coherence tomography (OCT) is a technology capable of capturing an internal structure of a sample in high resolution without contact by using an optical coherence phenomenon. Recently, a technology of the optical coherence tomography is also used to inspect defects in electronic components such as a semiconductor and a display.

### SUMMARY

The present disclosure provides an optical coherence tomography apparatus with reduced inspection time for a display device and a method for inspecting a display device using the same.

The present disclosure also provides an optical coherence tomography apparatus capable of preventing occurrence of distortion of an inspection result image and a method for inspecting a display device using the same.

An embodiment of the invention provides an optical coherence tomography apparatus including a light source configured to emit source light, a splitter configured to divide the source light into (1-1)-th light and (1-2)-th light, a reference group, which receives the (1-1)-th light, and including a mirror reflecting the received (1-1)-th light back to the splitter, a sample group configured to inspect a display panel using the (1-2)-th light and then reflect the (1-2)-th light reflected from the display panel back to the splitter, a detector configured to convert an interference signal into an electrical signal, and a processing unit configured to receive an electrical signal received from the detector and generate a tomographic image, where the splitter generates the interference signal by combining the (1-1)-th light reflected from the reference group and the (1-2)-th light reflected from the sample group, and speed at which the sample group inspects the display panel is variable.

In an embodiment of the invention, a method for inspecting a display device includes emitting source light from a light source, dividing, by a splitter, the source light into (1-1)-th light and (1-2)-th light, making the (1-1)-th light incident on a reference group and allowing a mirror of the reference group to reflect the incident (1-1)-th light toward the splitter, making the (1-2)-th light incident on a sample group where a display panel is disposed and emitting the (1-2)-th light scattered by the display panel toward the splitter, forming, by the splitter, an interference pattern by combining the (1-1)-th light reflected from the reference group and the scattered (1-2)-th light, and converting the interference pattern into an electrical signal, where a portion of the display panel to which the (1-2)-th light is irradiated is defined as inspection points, the inspection points are arranged in a plurality of concentric circular shapes, and speed at which the inspection points are arranged is variable depending on location of the inspection points.

### BRIEF DESCRIPTION OF THE FIGURES

The accompanying drawings are included to provide a further understanding of the invention, and are incorporated in and constitute a part of this specification. The drawings illustrate embodiments of the invention and, together with the description, serve to explain principles of the invention. In the drawings:

FIG. 1 is a schematic diagram of an optical coherence tomography apparatus according to an embodiment of the invention;

FIG. 2 is a perspective view for describing a scan unit illustrated in FIG. 1;

FIG. 3 is a perspective view of a display device inspected by the optical coherence tomography apparatus illustrated in FIG. 1;

FIG. 4 is an exploded perspective view of the display device illustrated in FIG. 3;

FIG. 5 is a block diagram of the display device illustrated in FIG. 3;

FIG. 6A is a plan view of a display unit illustrated in FIG. 5;

FIG. 6B is a signal circuit diagram of one pixel among pixels illustrated in FIG. 6A;

FIG. 7 is a plan view for describing a method for inspecting a hole by using the optical coherence tomography apparatus illustrated in FIG. 1;

FIG. 8 is a plan view for describing inspection of a hole according to Comparative Examples;

FIG. 9A is a graph illustrating rotation of a rotation mirror illustrated in FIG. 2 in terms of frequency;

FIG. 9B is a graph illustrating movement of a support plate illustrated in FIG. 2 in terms of frequency;

FIG. 9C is a plan view of a portion corresponding to a first region A1 in FIG. 7;

FIG. 9D is an image generated through a processing unit in FIG. 2;

FIG. 10A is a graph illustrating rotation of a rotation mirror according to Comparative Examples in terms of frequency;

FIG. 10B is a graph illustrating movement of a support plate according to Comparative Examples in terms of frequency;

FIG. 10C is a plan view illustrating inspection points arranged by frequencies in FIGS. 10A and 10B;

FIG. 10D is an image generated through a processing unit in FIG. 2;

FIG. 10E is an image generated by using a frequency according to Comparative Examples; and

FIG. 10F is an enlarged plan view of a second region illustrated in FIG. 10D.

### DETAILED DESCRIPTION

In this specification, it will be understood that when an element (or a region, a layer, a portion, or the like) is referred to as being “on”, “connected to” or “coupled to” another element, it may be directly disposed on, connected to, or coupled to the other element, or other elements may be disposed therebetween.

Like reference numerals or symbols refer to like elements throughout. Also, in the drawings, the thickness, ratio, and size of the elements are exaggerated for effectively describing the technical contents. As used herein, the term “and/or” includes any and all combinations of one or more of the associated listed elements.

It will be understood that, although the terms “first”, “second”, (1-1)-th, (1-2)-th, etc. may be used herein to describe various elements, the elements are not to be limited by these terms. These terms are only used to distinguish one element from another element. For instance, a first element discussed below could be termed a second element without departing from the scope of the invention. Similarly, a second element could be termed a first element. In this specification, the singular expressions “a”, “an” and “the” are intended to include the plural forms as well, unless the context clearly indicates otherwise.

In addition, the terms “below”, “under”, “on the lower side”, “above”, “over”, “on the upper side”, or the like may be used to describe the relationships between the elements illustrated in the drawings. These terms have relative concepts and are described on the basis of the directions indicated in the drawings.

It will be further understood that the terms “comprises, includes, has” and/or “comprising, including, having”, when used in this specification, specify the presence of stated features, numbers, steps, operations, elements, components, or combinations thereof, but do not preclude the possibility of the presence or addition of one or more other features, numbers, steps, operations, elements, components, and/or combinations thereof.

Unless otherwise defined, all terms (including technical and scientific terms) used herein have the same meaning as commonly understood by one of ordinary skills in the art to which this invention belongs. It will be further understood that terms, such as those defined in commonly used dictionaries, should be interpreted as having a meaning that is consistent with their meaning in the context of the relevant in art and will not be interpreted in an idealized or overly formal sense unless expressly so defined herein.

Hereinafter, embodiments of the invention are described with reference to the drawings.

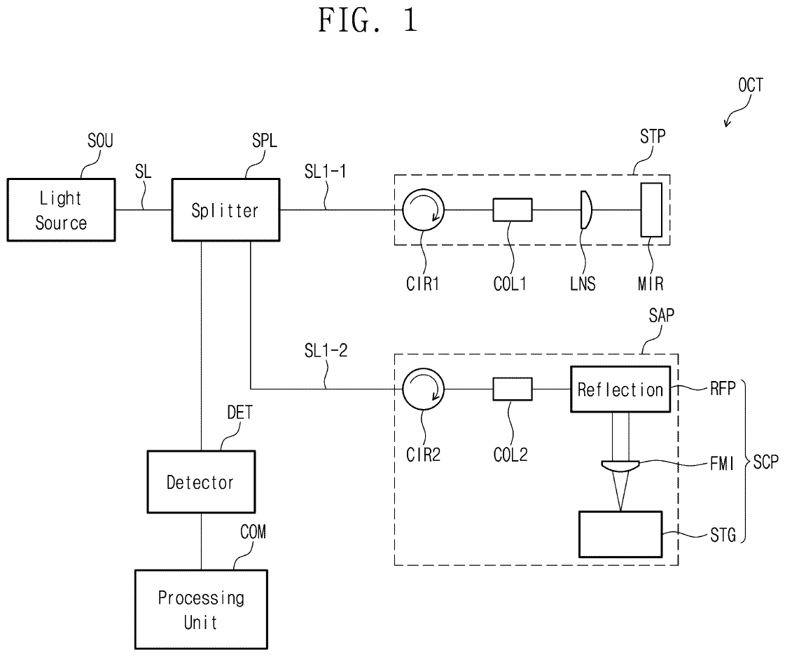

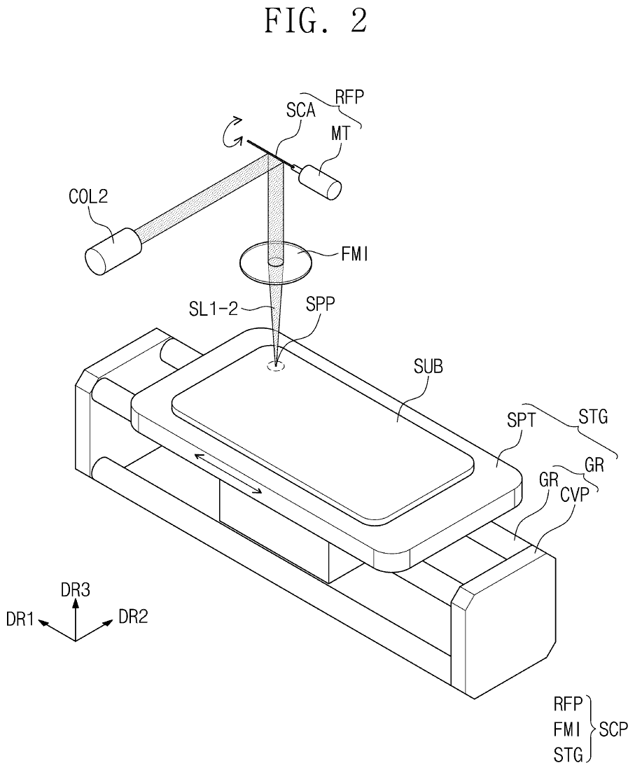

FIG. 1 is a schematic diagram of an optical coherence tomography apparatus OCT according to an embodiment of the invention. FIG. 2 is a perspective view for describing a scan unit SCP illustrated in FIG. 1.

Referring to FIG. 1, the optical coherence tomography apparatus OCT may include a light source SOU, a splitter SPL, a reference group STP, a sample group SAP, a detector DET, and a processing unit COM. The light source SOU may generate coherence light. The light source SOU may use swept-source optical coherence tomography (“SS-OCT”). The SS-OCT may be defined as an optical coherence tomography technology using a sweeping light source which quickly scans a wavelength according to time. The SS-OCT may include tunable laser, and the light source SOU may emit light having different wavelengths depending on time by using the tunable laser. The SS-OCT may include a semiconductor optical amplifier (“SOA”), and the SOA may amplify a light signal. The SOA may be defined as a device that improves quality of an interference signal by amplifying the light signal. Hereinafter, light SL emitted from the light source SOU may be referred to as source light SL.

The splitter SPL may divide the source light SL into (1-1)-th light SL1-1 incident on the reference group STP and (1-2)-th light SL1-2 incident on the sample group SAP. In addition, the splitter SPL may combine the (1-1)-th light SL1-1 reflected back from the reference group STP and the (1-2)-th light SL1-2 reflected back from the sample group SAP to cause interference.

Although not illustrated, the splitter SPL may include a light coupler. By the light coupler, the source light SL incident from the light source SOU may be divided at a certain ratio without light loss. For example, the light coupler may divide the (1-1)-th light SL1-1 and the (1-2)-th light SL1-2 in a ratio of 1:1. In addition, the reflected (1-1)-th light SL1-1 and the reflected (1-2)-th light SL1-2 may be combined by the light coupler.

The reference group STP may reflect the (1-1)-th light SL1-1 incident from the splitter SPL back toward the splitter SPL. The reference group STP may reflect the (1-1)-th light SL1-1 so as to generate an interference signal with the (1-2)-th light SL1-2 reflected from the sample group SAP. An optical path of the reference group STP may be changed depending on an optical path of the sample group SAP.

The reference group STP may include a first collimator COL1, a lens LNS, a mirror MIR, and a first circulator CIR1. When the (1-1)-th light SL1-1 spreads, the first collimator COL1 may turn the spreading light into light that is parallel to each other.

The lens LNS may correct a focus of the (1-1)-th light SL1-1 incident from the first collimator COL1. Since the focus of the (1-1)-th light SL1-1 is corrected by the lens LNS, the (1-1)-th light SL1-1 may be accurately irradiated to a specific point of the mirror MIR.

The mirror MIR may reflect the (1-1)-th light SL1-1 incident from the lens LNS. As the mirror MIR reflects the (1-1)-th light SL1-1, reference light, which is necessary for forming an interference signal, may be generated.

The (1-1)-th light SL1-1 reflected from the mirror MIR may pass through the first circulator CIR1 and re-enter the splitter SPL. The reflected (1-1)-th light SL1-1 may be controlled by the first circulator CIR1 to be directed toward the splitter SPL.

The sample group SAP may inspect a target substrate SUB using the (1-2)-th light SL1-2 incident from the splitter SPL. The sample group SAP may reflect the (1-2)-th light SL1-2, which is reflected from the target substrate SUB, back to the splitter SPL.

The sample group SAP may include a second collimator COL2, a scan unit SCP, and a second circulator CIR2. When the (1-2)-th light SL1-2 spreads, the second collimator COL2 may turn the spreading light into light that is parallel to each other.

Referring to FIGS. 1 and 2, the scan unit SCP may inspect the target substrate SUB using the (1-2)-th light SL1-2 incident from the second collimator COL2. For example, the scan unit SCP may be a Galvano scanner. The scan unit SCP may adjust, according to an input electrical signal, a location of a support plate SPT and an angle of a rotation mirror SCA to be described later, and may thus adjust a direction of the (1-2)-th light SL1-2 irradiated onto the target substrate SUB.

The scan unit SCP may include a reflection part RFP, a condensing lens FMI, and a stage STG. The reflection part RFP may include a motor portion MT and a rotation mirror SCA. The rotation mirror SCA may be connected to one side of the motor portion MT and may rotate around a rotation axis that is parallel to a first direction DR1. Specifically, when an external electrical signal is input to the motor portion MT, current may flow through a coil disposed inside the motor portion MT and the coil may be rotated. Accordingly, the rotation mirror SCA connected to the motor portion MT may be rotated around the rotation axis that is parallel to the first direction DR1.

As the rotation mirror SCA rotates, a path of the (1-2)-th light SL1-2, which is incident from the second collimator COL2 toward the rotation mirror SCA, may be changed rapidly.

The condensing lens FMI may condense the (1-2)-th light SL1-2 reflected from the rotation mirror SCA. By the condensing lens FMI, a focus of the (1-2)-th light SL1-2 may be corrected to be irradiated to a specific point of the target substrate SUB. Accordingly, an inspection result of the target substrate SUB may be irradiated in high resolution.

The stage STG may include the support plate SPT a plurality of guide rails GR and a plurality of cover parts CVP. The guide rails GR may extend in the first direction DR1. The guide rails GR may be arranged in the first direction DR1 and a second direction DR2 crossing the first direction DR1.

Hereinafter, a direction crossing the first direction DR1 will be defined as the second direction DR2. A direction substantially perpendicularly crossing a plane defined by the first and second directions DR1 and DR2 is defined as a third direction DR3. In this specification, “when viewed on a plane” may mean a “state viewed in the third direction DR3”.

The cover part CVP may be disposed at two sides of the guide rails GR which are opposite to each other in the first direction DR1. For example, it is illustrated that the cover part CVP has an octagonal shape, but the shape of the cover part CVP is not limited thereto.

The support plate SPT may be disposed on the guide rails GR. The support plate SPT may move back and forth in the first direction DR1 along the guide rails GR. An upper surface of the support plate SPT may be parallel to a plane defined by the first direction DR1 and the second direction DR2. The target substrate SUB may be disposed on the upper surface of the support plate SPT.

The (1-2)-th light SL1-2 passing through the condensing lens FMI may be irradiated to the target substrate SUB disposed on the stage STG. An inspection point SPP defined as a region of the target substrate SUB to which the (1-2)-th light SL1-2 is irradiated may be moved by the rotation mirror SCA and the stage STG, on the target substrate SUB. A movement of the inspection point SPP will be described in detail later.

When the (1-2)-th light SL1-2 is irradiated to the target substrate SUB having a structure in which a plurality of layers are stacked, a portion of the (1-2)-th light SL1-2 may be reflected. A portion of the (1-2)-th light SL1-2 may be reflected due to different refractive indexes at boundaries between the layers of the target substrate SUB.

Referring to FIG. 1, the reflected (1-2)-th light SL1-2 may pass through the second circulator CIR2 and re-enter the splitter SPL. The reflected (1-2)-th light SL1-2 may be controlled by the second circulator CIR2 to be directed toward the splitter SPL

The reflected (1-1)-th light SL1-1 and the reflected (1-2)-th light SL1-2 may be incident on the inside of the splitter SPL and combined. The (1-1)-th light SL1-1 and the (1-2)-th light SL1-2, which are combined, may produce an interference signal. A difference in light paths may be measured through the interference signal.

The detector DET may receive the interference signal from the splitter SPL and convert the signal into an electrical signal in a form of frequency. Specifically, the interference signal may reach a photoreceptor of the detector DET and electrical conversion may occur due to photoelectric effect. Since the light source SOU emits the source light SL having different wavelengths depending on time, the electrical signal may, in real-time, sense changes in the interference signal according to time.

The processing unit COM may receive the electrical signal from the detector DET and generate a tomographic image of the target substrate SUB (see FIG. 2). Information about an internal structure of the target substrate SUB may be obtained by the processing unit COM. Accordingly, it is possible to inspect whether foreign matters exist inside the target substrate SUB or not.

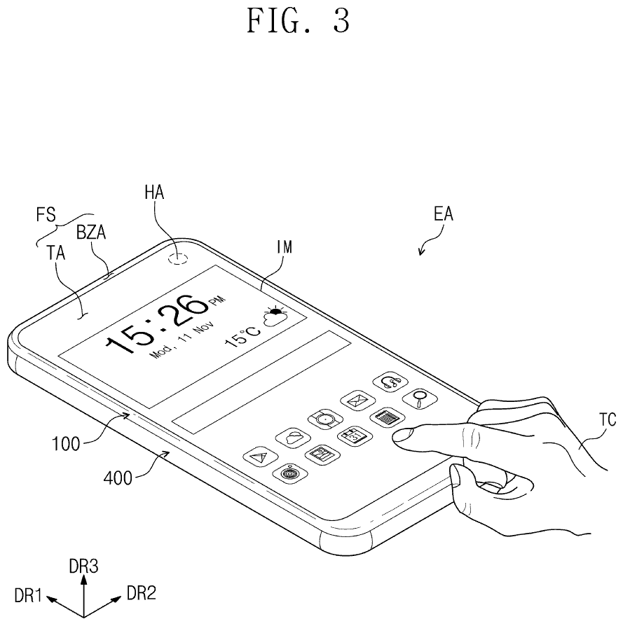

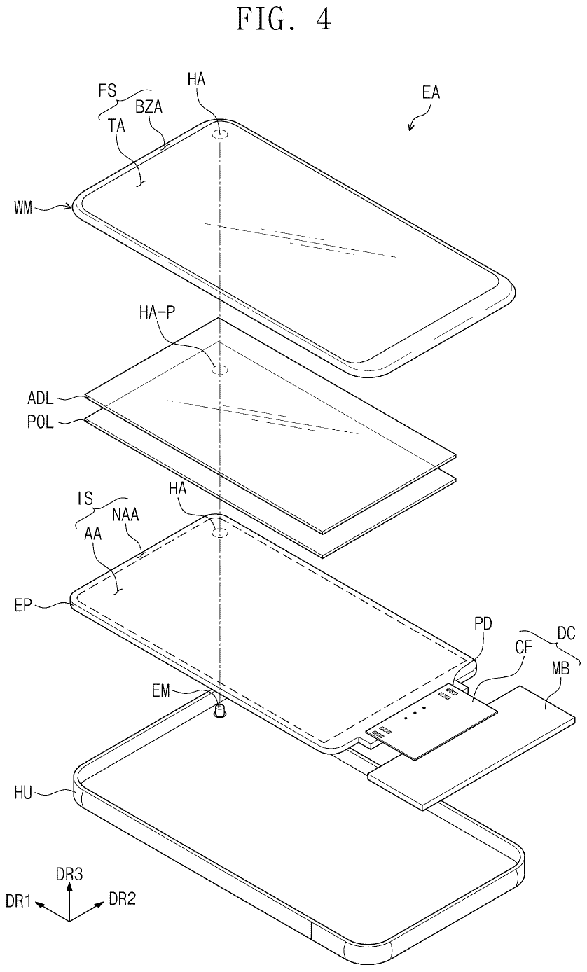

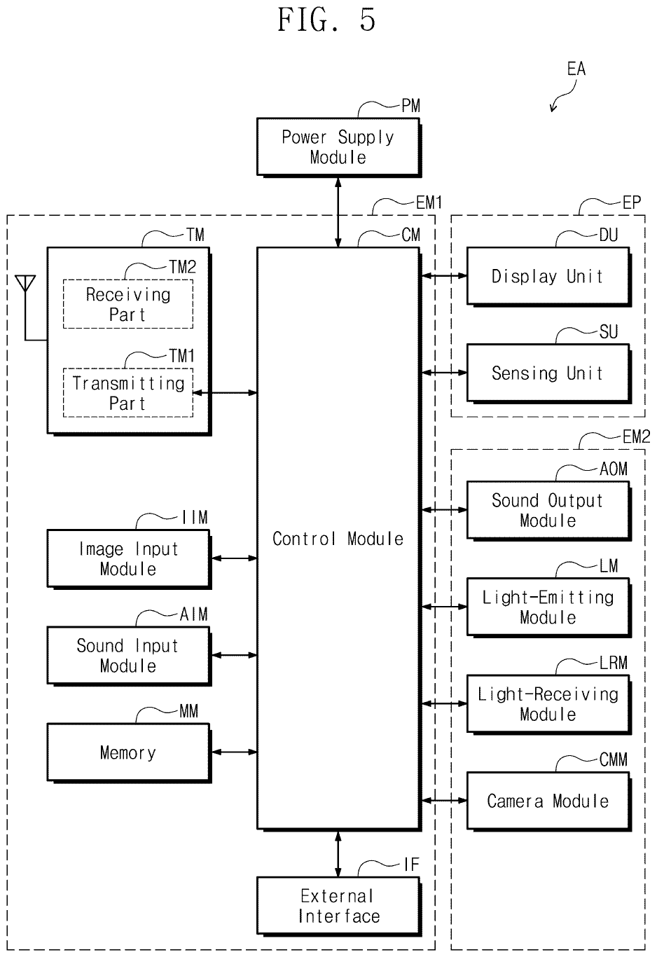

FIG. 3 is a perspective view of a display device EA inspected by the optical coherence tomography apparatus OCT illustrated in FIG. 1. FIG. 4 is an exploded perspective view of the display device EA illustrated in FIG. 3. FIG. 5 is a block diagram of the display device EA illustrated in FIG. 3.

Referring to FIGS. 3 and 4, the display device EA may be activated in response to an electrical signal. The display device EA may include various examples. For instance, the display device EA may include a tablet PC, a laptop, a computer, a smart television, and the like. In this embodiment, the display device EA is exemplarily illustrated as a smart phone.

As illustrated in FIG. 3, the display device EA may display an image IM on a front surface FS. The front surface may be defined as a surface that is parallel to a surface defined by a first direction DR1 and a second direction DR2. The front surface FS includes a transmission region TA and a bezel region BZA adjacent to the transmission region TA.

The display device EA displays the image IM in the transmission region TA. The image IM may include at least one of a static image or a dynamic image. In FIG. 3, a clock and a plurality of icons are illustrated as an example of the image IM.

The transmission region TA may have a quadrangular shape that is parallel to each of the first direction DR1 and the second direction DR2. However, this is exemplarily illustrated, and the transmission region TA may have various shapes and is not limited to any one embodiment.

The bezel region BZA is adjacent to the transmission region TA. The bezel region BZA may surround the transmission region TA. However, this is exemplarily illustrated, and the bezel region BZA may be disposed adjacent to only one side of the transmission region TA, or may be omitted. An electronic apparatus according to an embodiment of the invention may include various embodiments, and is not limited to any one embodiment.

A normal direction of the front surface FS may correspond to a thickness direction DR3 (hereinafter, a third direction) of the display device EA. In this embodiment, a front surface (or top surface) and a rear surface (or bottom surface) of each member are defined on the basis of a direction in which the image IM is displayed. The front surface and the rear surface are opposed to each other in the third direction DR3.

The display device EA according to the invention may sense a user's input TC applied from the outside. The user's input TC includes various types of external inputs such as a part of the user body, light, heat, or pressure. In addition, the display device EA may sense not only an input that touches the display device EA, but also an input that is proximate or adjacent to the display device EA.

In this embodiment, the user's input TC is illustrated as a user's hand applied to the front surface. However, this is exemplarily illustrated, and the user's input TC may be provided in various forms as mentioned above. In addition, the display device EA may sense the user's input TC applied to a side surface or rear surface of the display device EA depending on a structure of the display device EA, and is not limited to any one embodiment.

The display device EA may include a window WM, a display panel EP, an anti-reflection member POL, an adhesive layer ADL, a circuit board DC, an electronic module EM, and an external case HU. The window WM and the external case HU are coupled to define an exterior of the display device EA.

The window WM is disposed on the display panel EP to cover a front surface IS of the display panel EP. The window WM may include an optically transparent insulating material. For instance, the window WM may include glass or plastic. The window WM may have a multi- or single-layered structure. For instance, the window WM may have a stacked structure in which a plurality of plastic films are coupled by an adhesive, or may have a stacked structure in which a glass substrate and a plastic film are coupled by an adhesive.

The window WM includes a front surface FS exposed to the outside. The front surface FS of the display device EA may be substantially defined by the front surface FS of the window.

Specifically, the transmission region TA may be an optically transparent region. The transmission region TA may have a shape corresponding to an active region AA. For instance, the transmission region TA overlaps a front surface of the active region AA or at least a portion of the active region AA. An image IM displayed in the active region AA of the display panel EP may be visible from the outside through the transmission region TA.

The bezel region BZA may be a region having a relatively lower light transmittance than the transmission region TA. The bezel region BZA defines a shape of the transmission region TA. The bezel region BZA may be adjacent to the transmission region TA, and may surround the transmission region TA.

The bezel region BZA may have a color. When the window WM is provided as a glass or plastic substrate, the bezel region BZA may be a color layer printed on one surface of the glass or plastic substrate or a color layer deposited on one surface of the glass or plastic substrate. Alternatively, the bezel region BZA may be formed by coloring a corresponding region of the glass or plastic substrate.

The bezel region BZA may cover a peripheral region NAA of the display panel EP to block the peripheral region NAA from being visible from the outside. This is exemplarily illustrated, and the bezel region BZA may be omitted in the window WM according to an embodiment of the invention.

The display panel EP may display the image IM and sense an external input TC. The display panel EP includes the front surface IS including the active region AA and the peripheral region NAA. The active region AA may be activated in response to an electrical signal.

In this embodiment, the active region AA may be a region in which the image IM is displayed, and simultaneously a region in which the external input TC is sensed. The transmission region TA overlaps at least the active region AA. For instance, the transmission region TA overlaps a front surface of the active region AA or at least a portion of the active region AA. Accordingly, a user may view the image IM or provide the external input TC, through the transmission region TA. However, this is exemplarily illustrated, and in the active region AA, the region in which the image IM is displayed and the region in which the external input TC is sensed may be separated from each other. The invention is not limited to any one embodiment.

The peripheral region NAA may be a region covered by the bezel region BZA. The peripheral region NAA is adjacent to the active region AA. The peripheral region NAA may surround the active region AA. A driving circuit, driving wiring, or the like for driving the active region AA may be disposed in the peripheral region NAA.

Various signal lines or pads PD for providing an electrical signal to the active region AA, electronic elements, or the like may be disposed in the peripheral region NAA. The peripheral region NAA may be covered by the bezel region BZA to be invisible from the outside.

In this embodiment, the display panel EP is assembled in a flat state in which the active region AA and the peripheral region NAA face the window WM. However, this is exemplarily illustrated, and a portion of the peripheral region NAA of the display panel EP may be bent. Here, a portion of the peripheral region NAA may face a rear surface of the display device EA, and the bezel region BZA may be reduced in the front surface of the display device EA. Alternatively, the display panel EP may also be assembled in a state in which a portion of the active region AA is bent. Alternatively, the peripheral region NAA may be omitted in the display panel EP according to an embodiment of the invention.

The anti-reflection member POL is disposed between the window WM and the display panel EP. The anti-reflection member POL may lower reflectance of the display panel EP with respect to external light incident from the outside of the window WM. In this embodiment, the anti-reflection member POL may include a polarizing film. Alternatively, the anti-reflection member POL may include a color filter. When the anti-reflection member POL includes the color filter, the color filter may be directly formed on the display panel EP through a continuous process.

The adhesive layer ADL is disposed between the anti-reflection member POL and the window WM. The adhesive layer ADL couples the anti-reflection member POL and the window WM. The adhesive layer ADL may include an optically clear resin.

The anti-reflection member POL according to an embodiment of the invention may include an opening HA-P. The opening HA-P may be defined in a location corresponding to a hole HA of the display panel EP to be described later. The opening HA-P may be defined such that at least a portion of the opening overlaps the hole HA of the display panel EP. The opening HA-P may be a portion having a higher transmittance than surroundings.

Referring to FIGS. 3, 4, and 5, the display panel EP may include a display unit DU and a sensing unit SU. The display unit DU may be a component that substantially generates the image IM. The image IM, which the display unit DU generates, is visible to a user from the outside through the transmission region TA.

The sensing unit SU senses the external input TC applied from the outside. As mentioned above, the sensing unit SU may sense the external input TC provided to the window WM.

A hole HA may be defined in the display panel EP. The hole HA may have a relatively high transmittance compared to the same area of the active region AA. Specifically, a central region of the hole HA which serves as a path for light received by an electronic module EM may have the highest transmittance.

The hole HA is defined at a location, on a plane, overlapping the electronic module EM to be described later. The hole HA may be a region overlapping not only a portion of the electronic module EM which receives or outputs light but also a main body, which constitutes the electronic module EM, such as a body or housing.

A shape of the hole HA may be variously defined. In this embodiment, for convenience of explanation, it is illustrated that the hole HA has a circular shape, but an embodiment of the invention is not limited thereto. The hole HA may have various shapes such as an elliptical shape, a polygonal shape, and a figure having a curved side and a straight side, and is not limited to any one embodiment.

At least a portion of the hole HA may be surrounded by the active region AA. In this embodiment, the hole HA may be spaced apart from the peripheral region NAA. It is illustrated that a high transmission region HAA is defined within the active region AA such that an entire edge is surrounded by the active region AA. In a coupled state of the display device EA according to this embodiment, the hole HA may be defined at a location overlapping the transmission region TA and spaced apart from the bezel region BZA.

The circuit board DC may be connected to the display panel EP. The circuit board DC may include a flexible board CF and a main board MB. The flexible board CF may include an insulation film and conductive wiring mounted on the insulation film. The conductive wiring is connected to the pads PD to electrically connect the circuit board DC and the display panel EP.

In this embodiment, the flexible board CF may be assembled in a bent state. Accordingly, the main board MB may be disposed on a rear surface of the display panel EP and stably accommodated in a space that the external case HU provides. In this embodiment, the flexible board CF may be omitted, and in this case, the main board MB may be directly connected to the display panel EP.

The main board MB may include signal lines and electronic elements, which are not illustrated. The electronic elements may be connected to the signal lines to be electrically connected to the display panel EP. The electronic elements generate various electrical signals, for example signals for generating the image IM or sensing the external input TC, or process a sensed signal. The main board MB may be provided in plurality to correspond to the respective electrical signals for generating and processing, and is not limited to any one embodiment.

In the display device EA according to an embodiment of the invention, a driving circuit for providing an electrical signal to the active region AA may be directly mounted on the display panel EP. Here, the driving circuit may be mounted as a form of a chip, or may also be formed together with pixels PX. Here, an area of the circuit board DC may be reduced or omitted. The display device EA according to an embodiment of the invention may include various embodiments, and is not limited to any one embodiment.

The electronic module EM may be disposed under the window WM. The electronic module EM may overlap the hole HA on a plane. The electronic module EM may receive an external input transmitted through the hole HA or may provide an output through the hole HA. According to the invention, the electronic module EM may be disposed overlapping the active region AA, thereby preventing an increase in the bezel region BZA.

Referring to FIG. 5, the display device EA may include the display panel EP, a power supply module PM, a first electronic module EM1, and a second electronic module EM2. The display panel EP, the power supply module PM, the first electronic module EM1 and the second electronic module EM2 may be electrically connected to each other. FIG. 5 exemplarily illustrates the display unit DU and the sensing unit SU among the components of the display panel EP.

The first electronic module EM1 and the second electronic module EM2 include various functional modules for operating the display device EA. The first electronic module EM1 may be directly mounted on a motherboard that is electrically connected to an electronic panel 200 or may be mounted on a separate substrate to be electrically connected to the motherboard through a connector (not illustrated) or the like.

The first electronic module EM1 may include a control module CM, a wireless communication module TM, an image input module IIM, a sound input module AIM, a memory MM, and an external interface IF. Some of the above modules may not be mounted on the motherboard, and may be electrically connected to the motherboard through a flexible circuit board.

The control module CM controls overall operations of the display device EA. The control module CM may be a microprocessor. For instance, the control module CM may activate or deactivate the electronic panel 200. The control module CM may control other modules such as the image input module IIM or the sound input module AIM on the basis of a touch signal received from the electronic panel 200.

The wireless communication module TM may transmit/receive a wireless signal to/from another terminal using a Bluetooth or Wi-Fi line. The wireless communication module TM may transmit/receive a voice signal using a general communication line. The wireless communication module TM includes a transmitting part TM1 which modulates and transmits a signal to be transmitted and a receiving part TM2 which demodulates the received signal.

The image input module IIM may process an image signal and convert the signal into image data displayable in the display panel EP. The sound input module AIM may receive an external sound signal through a microphone in a recording mode, a voice recognition mode, or the like and may convert the signal into electrical voice data.

The external interface IF may serve as an interface connected to an external charger, a wired/wireless data port, a card socket (for example, a memory card, SIM/UIM card), and the like.

The second electronic module EM2 may include a sound output module AOM, a light-emitting module LM, a light-receiving module LRM, and a camera module CMM. The above components may be directly mounted on the motherboard, may be mounted on a separate substrate to be electrically connected to the display panel EP through a connector (not illustrated) or the like, or may be electrically connected to the first electronic module EM1.

The sound output module AOM converts the sound data received from the wireless communication module TM or the sound data stored in the memory MM and outputs the data to the outside.

The light-emitting module LM generates and outputs light. The light-emitting module LM may output infrared rays. For instance, the light-emitting module LM may include an LED element. For example, the light-receiving module LRM may sense infrared rays. The light-receiving module LRM may be activated when the infrared rays above a certain level are sensed. The light-receiving module LRM may include a CMOS sensor. After the infrared light generated from the light-emitting module LM is output, the light may be reflected by an external subject (for example, a user's finger or face) and the reflected infrared light may be incident on the light-receiving module LRM. The camera module CMM captures an external image.

The electronic module EM according to an embodiment of the invention may include at least one among the components of the first electronic module EM1 and the second electronic module EM2. For instance, the electronic module EM may include at least one of a camera, speaker, light detection sensor, or heat detection sensor. The electronic module EM may sense an external subject received through the hole HA or may provide a sound signal such as voice to the outside through the hole HA. In addition, the electronic module EM may also include a plurality of components, and is not limited to any one embodiment.

The electronic module EM disposed overlapping the hole HA may easily recognize an external subject through the hole HA or an output signal generated from the electronic module EM may be easily transmitted to the outside. Although not illustrated, the display device EA according to an embodiment of the invention may further include a transparent member disposed between the electronic module EM and the display panel EP. The transparent member may be an optically transparent film such that an external input transmitted through the hole HA passes through the transparent member and is transmitted to the electronic module EM. The transparent member may be attached to a rear surface of the display panel EP or may be disposed between the display panel EP and the electronic module EM without a separate adhesive layer. The display device EA according to an embodiment of the invention may have various structures, and is not limited to any one embodiment.

According to the invention, the electronic module EM may be assembled to overlap the transmission region TA on a plane. Accordingly, the aesthetic of the display device EA may be improved by preventing an increase in the bezel region BZA caused by accommodation of the electronic module EM.

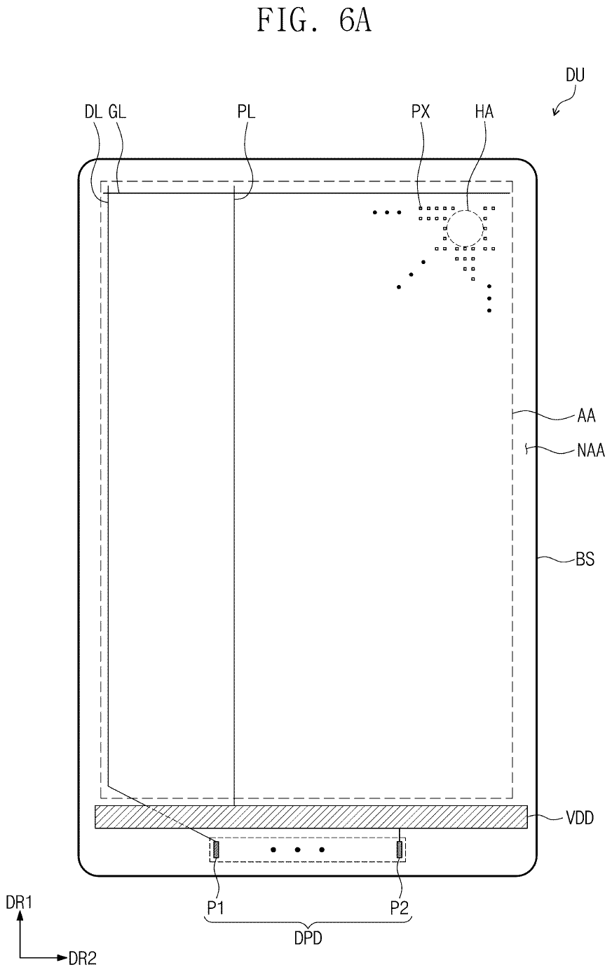

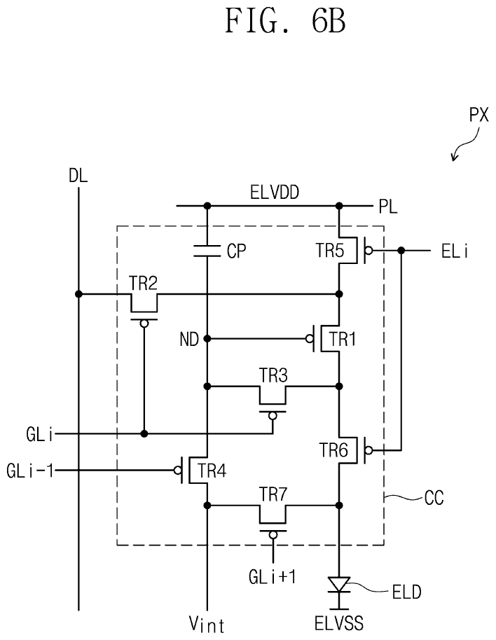

FIG. 6A is a plan view of the display unit DU illustrated in FIG. 5. FIG. 6B is a signal circuit diagram of one pixel PX among the pixels PX illustrated in FIG. 6A.

Among the components illustrated in FIGS. 6A and 6B, description of the components that are the same as the components described with reference to the aforementioned drawings will be omitted or simplified.

As illustrated in FIGS. 6A and 6B, the display unit DU includes a base substrate BS, a plurality of pixels PX, a plurality of signal lines GL, DL, and PL, a power supply pattern VDD, and a plurality of display pads DPD.

An active region AA and a peripheral region NAA may be regions provided by the base substrate BS. The base substrate BS may include an insulation substrate. For instance, the base substrate BS may be composed of a glass substrate, a plastic substrate, or a combination thereof.

Alternatively, the base substrate BS may also include a metal substrate. The base substrate BS may be flexibly provided so as to be foldable by a user or, may also be rigidly provided so as not to cause shape deformation. The base substrate BS according to an embodiment of the invention may include various embodiments, as long as the components such as the pixels PX or the signal lines GL, DL, and PL may be disposed on the base substrate BS, and is not limited to any one embodiment.

The signal lines GL, DL, and PL are connected to the pixels PX to transmit electrical signals to the pixels PX. FIG. 6A exemplarily illustrates a scan line GL, a data line DL, and a power supply line PL among the signal lines included in the display unit DU. However, this is exemplarily illustrated, and the signal lines GL, DL, and PL may further include at least any one of a power supply line, an initialization voltage line, or an emission control line. The invention is not limited to any one embodiment. In addition, for convenience of explanation, FIG. 6A exemplarily illustrates one scan line GL, one data line DL, and one power supply line PL among the signal lines, but an embodiment of the invention is not limited thereto. The scan line GL, the data line DL, and the power supply line PL may each be provided in plurality so as to transmit electrical signals to a plurality of pixel rows and pixel columns.

Referring to FIGS. 6A and 6B, the pixels PX may be disposed in the active region AA. FIG. 6B exemplarily illustrates the pixel PX connected to an i-th scan line GLi and an i-th emission control line ELi.

The pixel PX may include a light-emitting element ELD and a pixel circuit CC. The pixel circuit CC may include a plurality of transistors TR1 to TR7 and a capacitor CP. The plurality of transistors TR1 to TR7 may be formed through a low temperature polycrystalline silicon (LTPS) process, or a low temperature polycrystalline oxide (LTPO) process.

The pixel circuit CC controls amount of current flowing through the light-emitting element ELD in response to a data signal. The light-emitting element ELD may emit light at certain luminance corresponding to the amount of current provided from the pixel circuit CC. To this end, a level of a first power supply ELVDD may be set to be higher than a level of a second power supply ELVSS. The light-emitting element ELD may include an organic light-emitting element or a quantum dot light-emitting element.

The plurality of transistors TR1 to TR7 may each include an input electrode (or a source electrode), an output electrode (or a drain electrode), and a control electrode (or a gate electrode). In this specification, for convenience, any one among the input electrode and the output electrode may be referred to as a first electrode, and the other one may be referred to as a second electrode.

The first electrode of a first transistor TR1 is connected to the first power supply ELVDD via a fifth transistor TR5, and the second electrode of the first transistor TR1 is connected to an anode electrode of the light-emitting element ELD via a sixth transistor TR6. In this specification, the first transistor TR1 may be referred to as a driving transistor.

The first transistor TR1 controls amount of current flowing through the light-emitting element ELD corresponding to a voltage applied to the control electrode of the first transistor TR1.

A second transistor TR2 is connected between the data line DL and the first electrode of the first transistor TR1, and the control electrode of the second transistor TR2 is connected to the i-th scan line GLi. When an i-th scan signal is provided to the i-th scan line GLi, the second transistor TR2 is turned on and electrically connects the data line DL and the first electrode of the first transistor TR1.

A third transistor TR3 is connected between the second electrode of the first transistor TR1 and the control electrode of the first transistor TR1. The control electrode of the third transistor TR3 is connected to the i-th scan line GLi. When the i-th scan signal is provided to the i-th scan line GLi, the third transistor TR3 is turned on and electrically connects the second electrode of the first transistor TR1 and the control electrode of the first transistor TR1. Accordingly, when the third transistor TR3 is turned on, the first transistor TR1 is connected in a form of a diode.

A fourth transistor TR4 is connected between a node ND and an initialization power generation part (not illustrated), and the control electrode of the fourth transistor TR4 is connected to an (i−1)-th scan line GLi−1. When an (i−1)-th scan signal is provided to the (i−1)-th scan line GLi−1, the fourth transistor TR4 is turned on and provides an initialization voltage Vint to the node ND.

The fifth transistor TR5 is connected between the power supply line PL and the first electrode of the first transistor TR1. The control electrode of the fifth transistor TR5 is connected to the i-th emission control line ELi.

The sixth transistor TR6 is connected between the second electrode of the first transistor TR1 and the anode electrode of the light-emitting element ELD, and the control electrode of the sixth transistor TR6 is connected to the i-th emission control line ELi.

A seventh transistor TR7 is connected between the initialization power generation part (not illustrated) and the anode electrode of the light-emitting element ELD, and the control electrode of the seventh transistor TR7 is connected to an (i+1)-th scan line GLi+1. When an (i+1)-th scan signal is provided to the (i+1)-th scan line GLi+1, the seventh transistor TR7 like this is turned on and provides the initialization voltage Vint to the anode electrode of the light-emitting element ELD.

The seventh transistor TR7 may improve a black expression capability of the pixel PX. Specifically, when the seventh transistor TR7 is turned on, a parasitic capacitor (not illustrated) of the light-emitting element ELD is discharged. In this case, when implementing black luminance, the light-emitting element ELD may not emit light due to leakage current from the first transistor TR1, and thus the black expression capability may be improved.

Additionally, FIG. 6B illustrates that the control electrode of the seventh transistor TR7 is connected to the (i+1)-th scan line GLi+1, but an embodiment of the invention is not limited thereto. In another embodiment of the invention, the control electrode of the seventh transistor TR7 may be connected to the i-th scan line GLi or the (i−1)-th scan line GLi−1.

The capacitor CP is disposed between the power supply line PL and the node ND. The capacitor CP stores a voltage corresponding to the data signal. When the fifth transistor TR5 and the sixth transistor TR6 are turned on according to the voltage stored in the capacitor CP, the amount of current flowing through the first transistor TR1 may be determined.

According to the invention, an equivalent circuit of the pixel PX is not limited to the equivalent circuit illustrated in FIG. 6B. In another embodiment of the invention, the pixel PX may be implemented in various forms to cause the light-emitting element ELD to emit light. FIG. 6B illustrates on the basis of a PMOS, but an embodiment of the invention is not limited thereto. In another embodiment of the invention, the pixel circuit CC may be composed of an NMOS. In still another embodiment of the invention, the pixel circuit CC may be composed of a combination of the NMOS and the PMOS.

Referring to FIG. 6A again, the pixels PX are disposed around a hole HA. In this embodiment, a boundary between the hole HA and the active region AA may have a closed line shape. In this embodiment, it is exemplarily illustrated that the boundary between the hole HA and the active region AA has a circular shape.

The power supply pattern VDD is disposed in the peripheral region NAA. In this embodiment, the power supply pattern VDD is connected to the plurality of power supply lines PL. Accordingly, since the display unit DU includes the power supply pattern VDD, an equivalent first power supply signal may be provided to each of the pixels PX.

The display pads DPD may include a first pad P1 and a second pad P2. The first pad P1 may be provided in plurality to be connected to the respective data lines DL. The second pad P2 may be connected to the power supply pattern VDD and electrically connected to the power supply line PL. The display unit DU may provide electrical signals, which are provided from the outside through the display pads DPD, to the pixels PX. The display pads DPD may further include pads, other than the first pad P1 and the second pad P2, for receiving other electrical signals, and are not limited to any one embodiment.

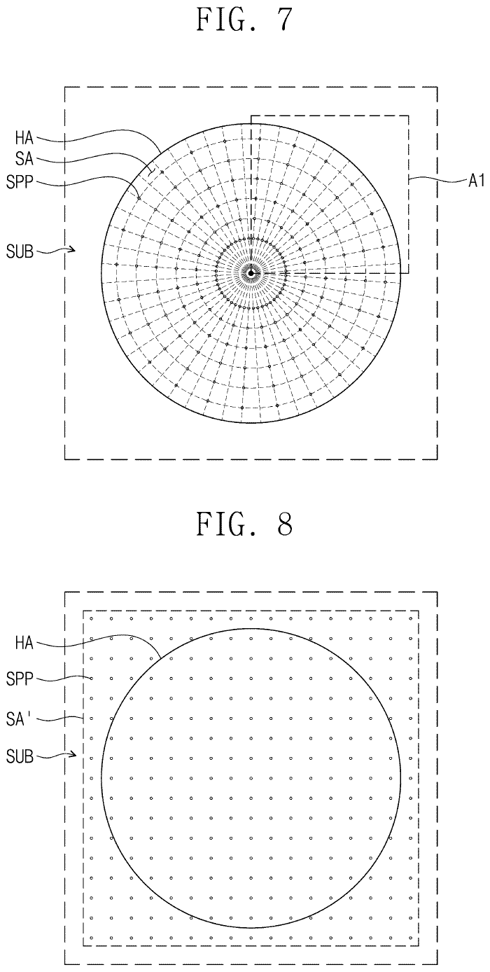

FIG. 7 is a plan view for describing a method for inspecting a hole HA by using the optical coherence tomography apparatus OCT illustrated in FIG. 1. FIG. 8 is a plan view for describing inspection of a hole HA according to Comparative Examples.

Among the components illustrated in FIGS. 7 and 8, description of the components that are the same as the components described with reference to the aforementioned drawings will be omitted or simplified.

Referring to FIGS. 1, 2, and 7, an inspection method of the display device ED (see FIG. 3) may include a step of emitting source light SL from a light source SOU after disposing a target substrate SUB on a support plate SPT. The target substrate SUB may be the display unit DU illustrated in FIG. 6A.

After the source light SL is emitted, a step of dividing the source light SL into (1-1)-th light SL1-1 and (1-2)-th light SL1-2 by a splitter SPL may be performed. The (1-1)-th light SL1-1 may be incident on a reference group STP, and the (1-2)-th light SL1-2 may be incident on a sample group SAP.

After the (1-1)-th light SL1-1 is incident on the reference group STP, the light may be reflected back by a mirror MIR and incident on the splitter SPL. The (1-2)-th light SL1-2 may enter the sample group SAP to be incident toward an inspection region SA overlapping a hole HA of the target substrate SUB. The inspection region SA may be defined as a portion of the target substrate SUB that is inspected.

Specifically, the (1-2)-th light SL1-2 may be incident on a reflection part RFP from a second collimator COL2. A rotation mirror SCA may reflect the (1-2)-th light SL1-2. The rotation mirror SCA may be rotated by a motor portion MT with respect to a rotation axis that is parallel to a first direction DR1, and a path of the (1-2)-th light SL1-2 may be changed.

The (1-2)-th light SL1-2 may pass through a condensing lens FMI and proceed toward the target substrate SUB. Here, the support plate SPT may move back and forth in the first direction DR1 along guide rails GR. The rotation of the rotation mirror SCA and the round-trip movement of the support plate SPT may occur simultaneously. Accordingly, as illustrated in FIG. 7, inspection points SPP may be arranged in a plurality of concentric circular shapes on the inspection region SA.

As illustrated in FIG. 8, when an inspection region SA′ is set to be a hole HA and an adjacent portion of a target substrate SUB adjacent to the hole HA, a portion of the target substrate SUB that does not require inspection may also be inspected. The inspection points SPP, on the portion of the target substrate SUB that does not require inspection, may be irradiated. Accordingly, inspection time of the target substrate SUB may increase.

However, in case of the optical coherence tomography apparatus OCT according to an embodiment of the invention, the inspection region SA is set to have a shape corresponding to a shape of the hole HA, and the inspection points SPP on such an inspection region SA may be irradiated, thereby reducing the inspection time.

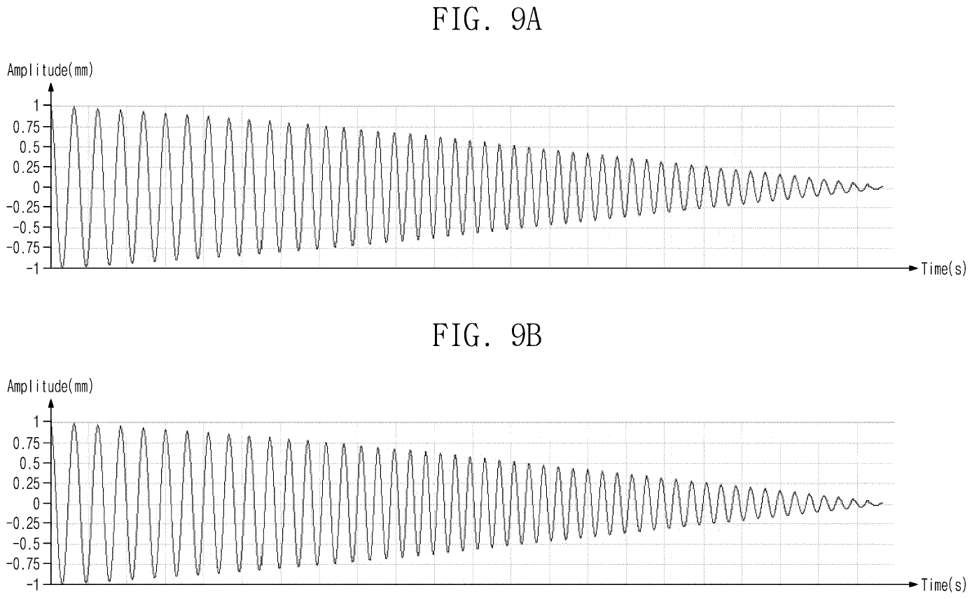

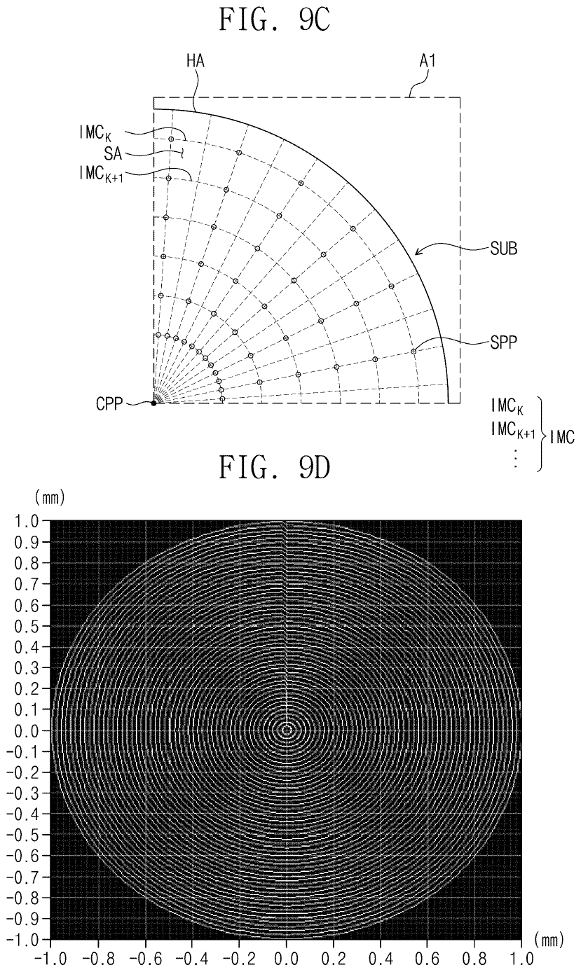

FIG. 9A is a graph illustrating rotation of the rotation mirror SCA illustrated in FIG. 2 in terms of frequency. FIG. 9B is a graph illustrating movement of the support plate SPT illustrated in FIG. 2 in terms of frequency. FIG. 9C is a plan view of a portion corresponding to a first region A1 in FIG. 7. FIG. 9D is an image generated through the processing unit COM in FIG. 2.

Among the components illustrated in FIGS. 9A to 9D, description of the components that are the same as the components described with reference to the aforementioned drawings will be omitted or simplified.

Referring to FIGS. 9A to 9C, the x-axis of each graph illustrated in FIGS. 9A and 9B may be defined as inspection time. The y-axis in FIG. 9A may be defined as an amplitude of a signal applied to the rotation mirror SCA (see FIG. 2). The y-axis in FIG. 9B may be defined as an amplitude of a signal applied to the support plate SPT (see FIG. 2).

In the graphs in FIGS. 9A and 9B, a cycle may be defined as the time it takes to surround a center CPP of the hole HA once. The amplitude may be defined as a radius of virtual circles IMC.

Referring to FIGS. 9A to 9C, since the rotation mirror SCA and the support plate SPT move simultaneously, inspection points SPP may be arranged in a plurality of concentric circular shapes on an inspection region SA. The inspection points SPP may be arranged on the circumference of the virtual circles IMC.

Sizes of the virtual circles IMC may be different from each other. For example, a size of a k-th virtual circle IMCₖ may be greater than a size of a (k+1)-th virtual circle IMCₖ₊₁ in increasing order of distance from the center CPP of the hole. k is a natural number greater than or equal to 1. Accordingly, a size of the amplitude may be reduced.

As the sizes of the virtual circles IMC change, spacing between the inspection points SPP disposed adjacent to each other on the same virtual circles IMC may vary. For example, the spacing between the inspection points SPP disposed on the k-th virtual circle IMCₖ may be greater than the spacing between the inspection points SPP disposed on the (k+1)-th virtual circle IMC_{k+1.}

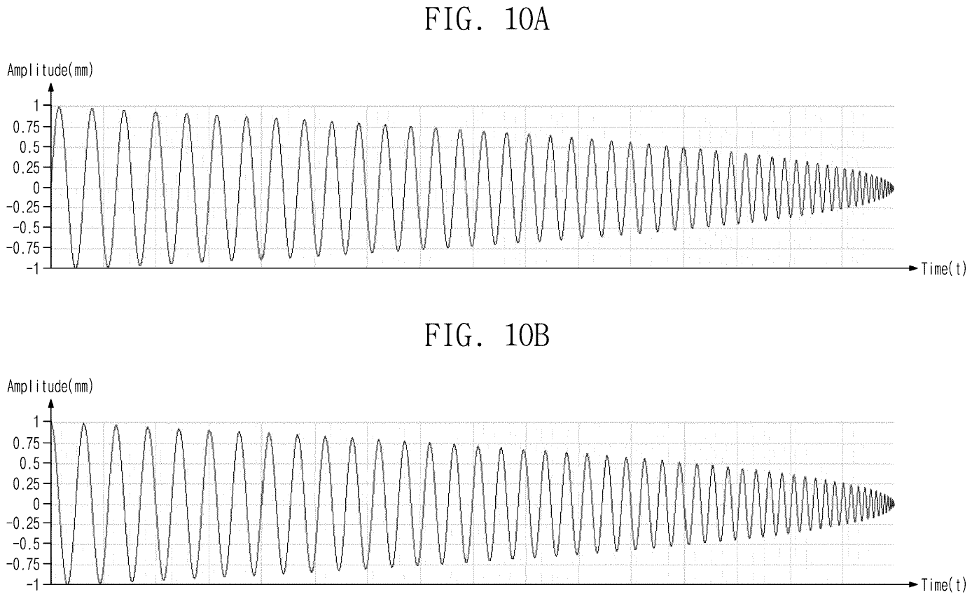

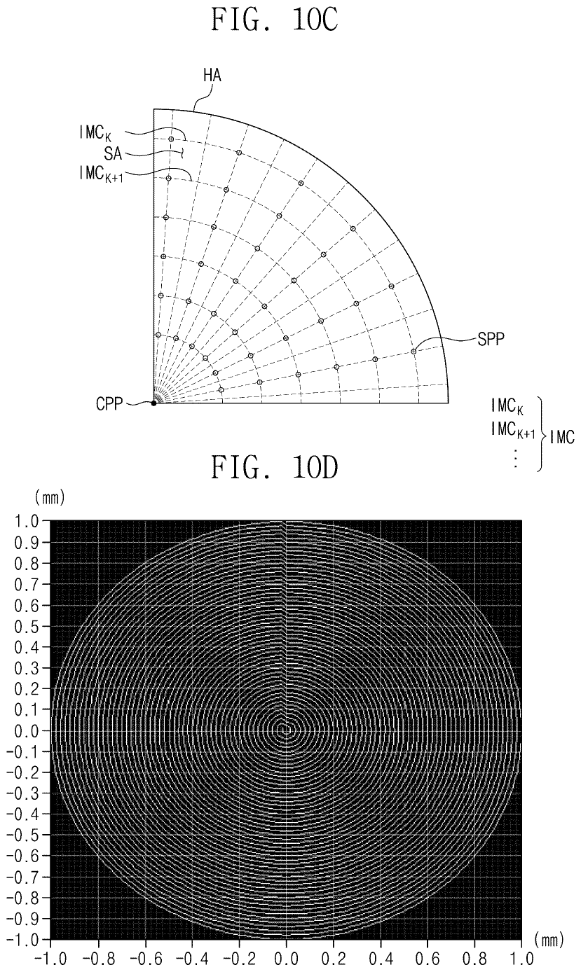

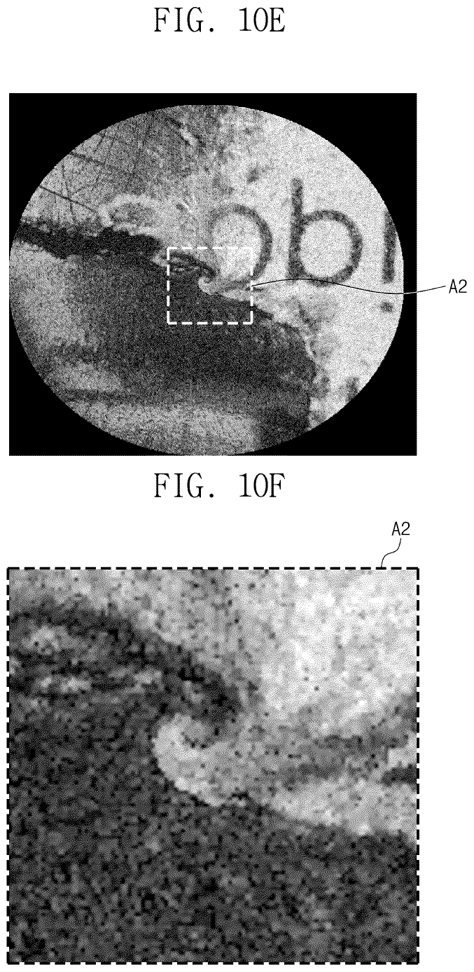

FIG. 10A is a graph illustrating rotation of a rotation mirror SCA according to Comparative Examples in terms of frequency. FIG. 10B is a graph illustrating movement of a support plate SPT according to Comparative Examples in terms of frequency. FIG. 10C is a plan view illustrating inspection points SPP arranged by the frequencies in FIGS. 10A and 10B. FIG. 10D is an image generated through the processing unit COM in FIG. 2. FIG. 10E is an image generated by using a frequency according to Comparative Examples. FIG. 10F is an enlarged plan view of a second region A2 illustrated in FIG. 10D.

For example, FIGS. 10D to 10F are images generated through the processing unit COM in FIG. 2 when the frequency illustrated in FIGS. 10A and 10B is applied.

Referring to FIGS. 10A and 10B, the x-axis of each graph illustrated in FIGS. 10A and 10B may be defined as inspection time. The y-axis in FIG. 10A may be defined as a frequency of a signal applied to the rotation mirror SCA (see FIG. 2). The y-axis in FIG. 10B may be defined as a frequency of a signal applied to the support plate SPT (see FIG. 2).

Referring to FIGS. 10A to 10C, sizes of virtual circles IMC may become smaller toward a center CPP of a hole HA. Spacing between the inspection points SPP adjacent to each other on the same virtual circle IMC may become smaller toward the center CPP of the hole HA.

A rotation angle of the rotation mirror SCA (see FIG. 2) which is necessary for arranging the inspection points SPP on the circumference of the virtual circle IMC may become smaller toward the center CPP of the hole HA. A movement distance of the support plate SPT (see FIG. 2) which is necessary for arranging the inspection points SPP on the circumference of the virtual circle IMC may become smaller toward the center CPP of the hole HA.

Accordingly, a cycle it takes for the inspection points SPP to surround the center CPP of the hole HA once may be reduced. The frequency applied to the rotation mirror SCA (see FIG. 2) and the support plate SPT (see FIG. 2) may become greater toward the center CPP of the hole HA,

Referring to FIGS. 10A to 10F, since the rotation mirror SCA (see FIG. 2) rotates at rapid speed due to the increase of the frequency, the virtual circles IMC may become distorted in a region adjacent to the center CPP of the hole HA, as illustrated in FIG. 10D. An arrangement of the inspection points SPP may be distorted due to the distortion of the virtual circles IMC. Accordingly, as illustrated in FIGS. 10D and 10E, an inspection result image may be generated to be distorted.

Referring to FIGS. 9A to 9D, in the scan unit SCP (see FIG. 2) according to an embodiment of the invention, the number of the irradiated inspection points SPP in each of the virtual circles IMC may differ. The number of the inspection points SPP arranged on the circumference of the virtual circle IMC adjacent to the center CPP of the hole HA may be greater than the number of the inspection points SPP arranged on the circumference of the virtual circle IMC spaced apart from the center CPP of the hole HA.

As the number of the inspection points SPP disposed on the circumference of the virtual circle IMC adjacent to the center CPP of the hole HA increases, a cycle it takes for the inspection points SPP to surround the center CPP of the hole HA one turn may become longer. The frequency applied to the rotation mirror SCA and the frequency applied to the support plate SPT may be reduced. Accordingly, as illustrated in FIG. 9D, distortion of the inspection result image may be effectively reduced or prevented.

According to an embodiment of the invention, light emitted from an optical coherence tomography apparatus is irradiated onto a display panel, and a hole defined in the display panel may be inspected. An inspection region overlapping the hole may correspond to a shape of the hole. Accordingly, regions of the display panel other than a region of the hole may not be inspected, thereby effectively reducing inspection time.

According to an embodiment of the invention, as irradiated inspection points in the inspection region become closer to a center of the hole, a rotation angle of a rotation mirror may be reduced. Accordingly, in a region adjacent to the center of the hole, an arrangement of the inspection points may not be distorted. Therefore, occurrence of distortion of an inspection result image may be effectively reduced or prevented

In the above, description has been made with reference to embodiments, but those skilled in the art or those of ordinary skill in the relevant technical field may understand that various modifications and changes may be made to the invention within the scope not departing from the spirit and the technology scope of the invention described in the claims to be described later. In addition, embodiments disclosed in the invention are not intended to limit the technical spirit of the invention, and all technical ideas within the scope of the following claims and their equivalents should be construed as being included in the scope of the invention.

What is claimed is:

1. An optical coherence tomography apparatus comprising:
a light source configured to emit source light;
a splitter configured to divide the source light into (1-1)-th light and (1-2)-th light;
a reference group, which receives the (1-1)-th light, and including a mirror configured to reflect the received (1-1)-th light back to the splitter;
a sample group configured to inspect a display panel using the (1-2)-th light, and then reflect the (1-2)-th light reflected from the display panel back to the splitter;
a detector configured to convert an interference signal into an electrical signal; and
a processing unit configured to receive the electrical signal from the detector and generate a tomographic image,
wherein the splitter generates the interference signal by combining the (1-1)-th light reflected from the reference group and the (1-2)-th light reflected from the sample group,
wherein speed at which the sample group inspects the display panel is variable.

2. The optical coherence tomography apparatus of claim 1, wherein the light source comprises a variable light source which emits the source light, which has different wavelengths depending on time.

3. The optical coherence tomography apparatus of claim 1, wherein the reference group further comprises:
a first collimator configured to adjust the (1-1)-th light incident from the splitter to be parallel to each other;
a lens configured to correct the (1-1)-th light incident from the first collimator; and
a first circulator configured to control the (1-1)-th light reflected from the mirror to be directed to the splitter.

4. The optical coherence tomography apparatus of claim 1, wherein the sample group comprises:
a second collimator configured to adjust the (1-2)-th light incident from the splitter to be parallel;
a scan unit configured to inspect a hole defined in the display panel by using the (1-2)-th light; and
a second circulator configured to control the (1-2)-th light scattered from the scan unit to be directed to the splitter.

5. The optical coherence tomography apparatus of claim 4, wherein the scan unit comprises:
a rotation mirror configured to rotate around a rotation axis that is parallel to a first direction;
a stage on which the display panel is disposed, and which moves back and forth in the first direction; and
a condensing lens disposed between the rotation mirror and the stage.

6. The optical coherence tomography apparatus of claim 5, wherein a region of the display panel to which the (1-2)-th light is irradiated is defined as a plurality of inspection points, the plurality of inspection points are arranged in concentric circular shapes on a region overlapping the hole, and centers of the concentric circular shapes correspond to a center of the hole.

7. The optical coherence tomography apparatus of claim 6, wherein a total number of inspection points, of the plurality of inspection points, arranged in a circular shape adjacent to the center of the hole is greater than a total number of the inspection points, of the plurality of inspection points, arranged in a circular shape spaced apart from the center of the hole.

8. The optical coherence tomography apparatus of claim 6, wherein time for inspection points, of the plurality of inspection points, arranged in a circular shape adjacent to the center of the hole is longer than time for inspection points, of the plurality of inspection points, arranged in a circular shape spaced apart from the center of the hole.

9. The optical coherence tomography apparatus of claim 8, wherein as the inspection points become closer to the center of the hole, rotation speed of the rotation mirror and movement speed of the stage become slow.

10. A method for inspecting a display device, the method comprising:
emitting source light from a light source;
dividing, by a splitter, the source light into (1-1)-th light and (1-2)-th light;
making the (1-1)-th light incident on a reference group, and allowing a mirror of the reference group to reflect the incident (1-1)-th light toward the splitter;
making the (1-2)-th light incident on a sample group where a display panel is disposed, and emitting the (1-2)-th light scattered by the display panel toward the splitter;
forming, by the splitter, an interference pattern by combining the (1-1)-th light reflected from the reference group and the scattered (1-2)-th light; and
converting the interference pattern into an electrical signal,
wherein a portion of the display panel to which the (1-2)-th light is irradiated is defined as a plurality of inspection points, the inspection points are arranged in a plurality of concentric circular shapes, and speed at which the inspection points are arranged is variable depending on location of the inspection points.

11. The method of claim 10, wherein the inspection points overlap a hole defined in the display panel, and
inspection speed of the inspection points in a region adjacent to a center of the hole is slower than inspection speed of the inspection points in a region spaced apart from the center of the hole.

12. The method of claim 11, wherein the light source comprises a variable light source which emits the source light, which has different wavelengths depending on time.

13. The method of claim 11, wherein the reference group further comprises:
a first collimator configured to adjust the (1-1)-th light incident on the reference group to be parallel;
a lens configured to correct the (1-1)-th light incident from the first collimator; and
a first circulator configured to control the (1-1)-th light reflected from the mirror to be directed to the splitter.

14. The method of claim 13, wherein the sample group comprises:
a second collimator configured to adjust the (1-2)-th light incident on the sample group to be parallel;
a scan unit configured to scan the hole defined in the display panel by using the (1-2)-th light; and
a second circulator configured to control the (1-2)-th light scattered from the scan unit to be directed to the splitter.

15. The method of claim 14, wherein the scan unit comprises:
a rotation mirror configured to rotate around a rotation axis that is parallel to a first direction, and configured to reflect the (1-2)-th light such that the inspection points are arranged in a second direction crossing the first direction;
a stage on which the display panel is disposed, and which moves back and forth in the first direction; and
a condensing lens disposed between the rotation mirror and the stage.

16. The method of claim 15, wherein when the (1-2)-th light is irradiated to the display panel, rotation of the rotation mirror and movement of the stage are performed simultaneously.

17. The method of claim 15, wherein time it takes for inspection points, of the plurality of inspection points, arranged in a circular shape adjacent to a center of the hole is defined as a first cycle,
time it takes for inspection points, of the plurality of inspection points, arranged in a circular shape spaced apart from the center of the hole is defined as a second cycle,
centers of the concentric circular shapes correspond to the center of the hole, and
the first cycle is greater than the second cycle.

18. The method of claim 15, wherein the rotation mirror is rotated by receiving an external electrical signal, and
as the inspection points become closer to the center of the hole, frequency of the external electrical signal decreases.

19. The method of claim 15, wherein the stage is moved by receiving an external electrical signal, and
as the inspection points become closer to the center of the hole, frequency of the external electrical signal decreases.

20. The method of claim 10, further comprising generating a tomographic image with the electrical signal by transmitting the electrical signal to a processing unit.
